(19) United States
(12) Patent Application Publication
(10) Pub. No.: US 2019/0360247 A1
(43) Pub. Date: Nov. 28, 2019

(54) DEVICE FOR SLIDING OF DOORS COATED WITH INDUSTRIAL LAMINATES

(71) Applicant: TERNO SCORREVOLI S.P.A. UNIPERSONALE, 4 Varedo (MB) (IT)

(72) Inventor: Giovanni TERNO, Varedo (MB) (IT)

(21) Appl. No.: 16/478,241

(22) PCT Filed: Mar. 20, 2018
(86) PCT No.: PCT/EP2018/000103

§ 371 Date: Jul. 16, 2019

(30) Foreign Application Priority Data
Mar. 22, 2017 (IT) 102017000031693

(51) Int. Cl. E05D 15/06; E05F 5/00

(52) U.S. Cl. CPC E05D 15/063; E05Y 2900/132; E05Y 2600/46; E05F 5/003

(57) ABSTRACT

A device for sliding of doors (10) coated with industrial laminates, in particular coated with “laminatino”, wherein said doors slide with respect to a wall (14) where a passage space (12) is obtained, comprising a guide profile section (28) with a support base (30), placed at the upper end of the door itself and provided with an upside down “U”-shaped seat (20), along which the wheels (18) of one or more trolleys slide, and at least one cushioned stop (22). The profile section (28) is secured to the door (10) starting from its base (30) with screws (32) or equivalent means, fitted vertically along the upper head (10′) of the door itself; said base (30) of the profile section (28) is bent orthogonally upwards, to form an integral wall (34) that aligns with the coated front side (36) of the door (10).

This invention relates to a device for sliding doors coated with industrial laminates. More particularly, this invention refers to a device specially suitable to the sliding movement of the wings or doors that separate two rooms and that are provided with a coat formed by industrial laminates of standard dimensions.

As is known, the sliding doors separating two rooms are widespread and appreciated because they do not angularly orientate in the opening, occupying space, but slide parallel and adjacent to the wall on which the opening is made. For sliding doors, specific devices are used, comprising an upper guide secured to the wall for the sliding of one or more trolleys from which an appendage that is connected to the upper end of the door protrudes below; a complementary lower guide is generally integrated flush with the floor and wheels or skids connected to the lower edge of the same door slide inside it. A solution of this kind is described in the patent application EP 2 913 468 A1 of the same applicant.

EP 2 646 635, on the other hand, concerns a sliding door in which the guide and support means guarantee both a small footprint in relation to the extension of the relative doorway, and the possibility of carrying out installation and maintenance operations quickly and easily.

Furthermore, EP 1 725 729 refers to a suspension system for a sliding door, in which the sliding profile section is secured to the wall and extends in length for a dimension equal to about twice the width of the doorway to be shielded.

A known type of sliding doors provides that they are made of honeycomb and unpainted panels, are covered with a thin sheet of synthetic material or paper, suitably processed, called “laminatino”, reproducing the effect of wood in the various species or other decorations or colors and forming the finish of these doors. The laminate is made according to standard dimensions that influence the height of the sliding doors; this dimension is typically 2,150 mm. It follows that a door having a height of 2,100 mm can be coated with laminatino with a height of 2,150 mm as a part corresponding to the remaining 50 mm remains available for processing, while this is not possible for a door with a height equal to or greater than 2,200 mm. The height of the door or wing is dictated by the height of the opening made in the wall; despite the preset measures, it often happens that the height of the finished opening is higher, albeit slightly, than the conventional height of 2,100 mm, thus making it impossible to use a sliding door coated in laminate. There is also a different size of the laminatino, with a much greater height than the one specified above; however, its use in this specific sector would lead to a considerable waste of material, as the doors intended for non-standardized rooms would, however, only slightly exceed the size of 2,150 mm.

The object of the present invention is to obviate the aforementioned drawbacks.

More particularly, the object of this invention is that of providing a device for sliding doors that allows to use doors coated with laminatino even in the presence of a wall opening having a height greater than 2,100 mm or, in any case, a height not compatible with the corresponding size of the laminate.

A further object of the invention is to provide a device for sliding doors as defined above that allows avoiding the traditional operations necessary for lowering the door and casing the sliding profile section flush with the door.

Not least object of the invention is to provide users with a sliding device for doors that adequately and completely covers the light of the doorway made in the wall, without creating undesired anti-aesthetic effects.

A further object of the invention is to provide users with a device for sliding doors to ensure a high level of resistance and reliability over time, such as to be easily and economically manufactured.

These and other objects are achieved by the device for sliding doors coated with industrial laminates of this invention according to the main claim.

The constructive and functional characteristics of the device for sliding doors coated with industrial laminates of this invention can be better understood from the detailed description below, in which reference is made to the attached tables of drawings representing a preferred and non-limiting embodiment thereof and in which:

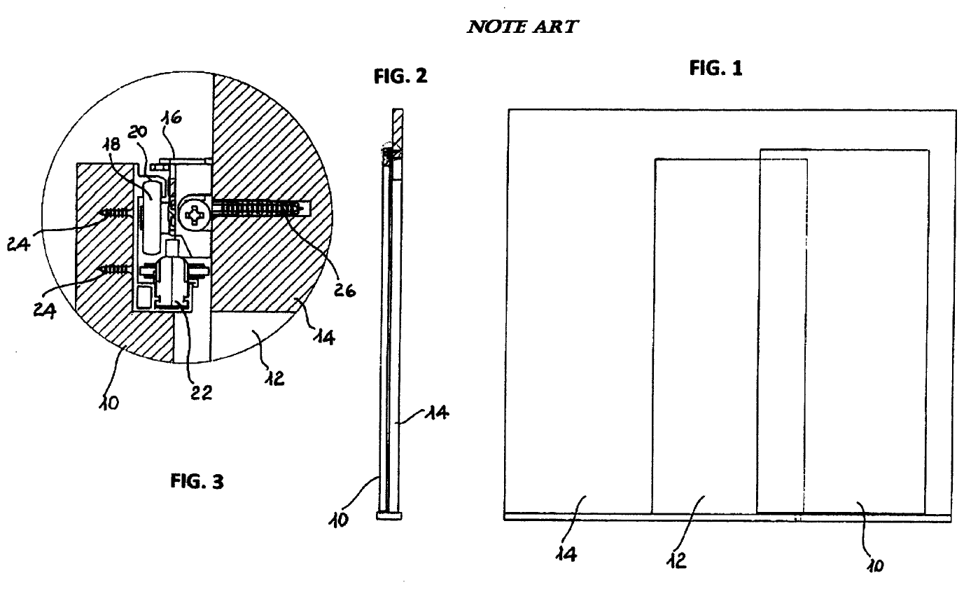

FIG. 1 is a schematic front view of the opening or passage space created in a wall and the relevant sliding door that closes the same space according to the known reference art;

FIG. 2 is a schematic sectional view of said wall and wing according to FIG. 1;

FIG. 3 is a schematic view of an enlarged detail of FIG. 2, showing the lowering created on the wing according to the traditional solution for housing the sliding profile section of the trolley;

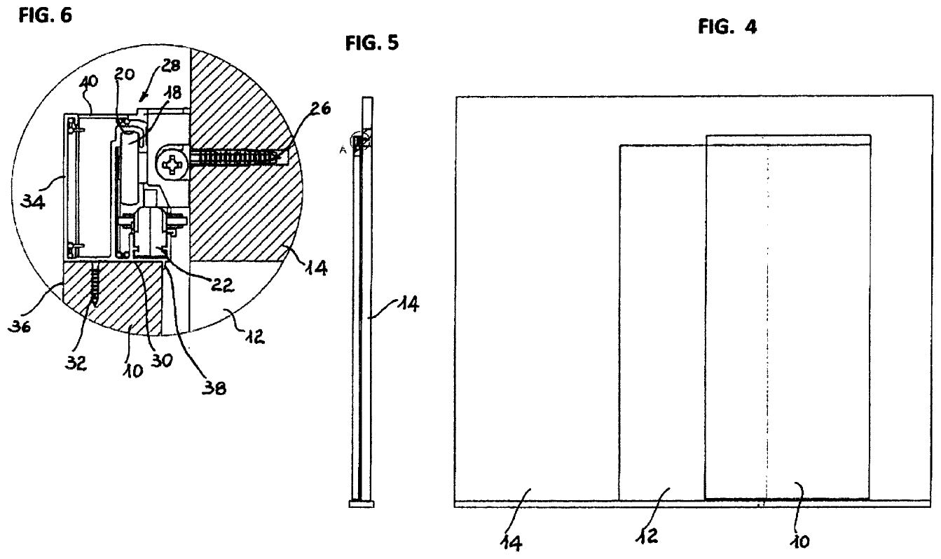

FIG. 4 is a schematic front view of the opening or passage space created in a wall and the corresponding sliding door that closes the same space according to the invention;

FIG. 5 is a schematic sectional view of said wall and wing according to FIG. 4;

FIG. 6 is a schematic view of an enlarged detail of FIG. 5, showing the end connection between the profile section and the wing or door;

FIG. 7 is a schematic axonometric view of the wall with the space and of the sliding door according to the invention intended to close the space itself;

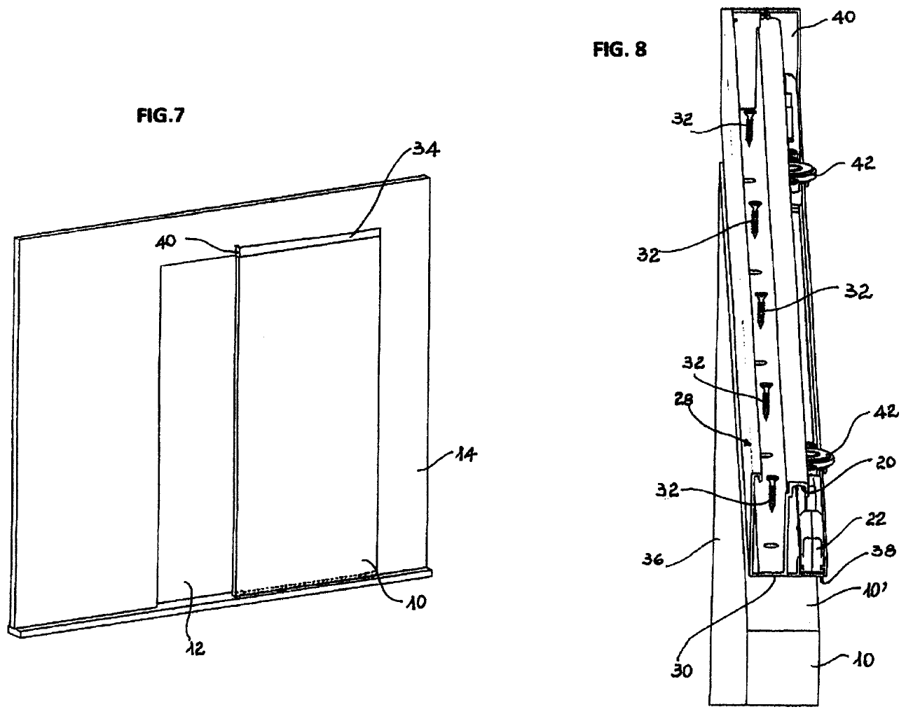

FIG. 8 is a schematic top view of the sliding device of the invention that is secured to the door.

The initial reference is to FIGS. 1 to 3, showing a solution designed by the same applicant to manufacture the sliding of a door 10, so as to lead it to temporarily close a passage space 12 created in a wall 14; it should be noted, from FIG. 1, that the door 10 can completely shield the space 12 only if it has a height at least equal, preferably higher, than that of the space. If the material with which the door 10 is coated does not reach the required height, as it does not exceed the standard size of 2,150 mm, the door with this coating cannot be used. Furthermore, with reference to FIG. 3, it should be noted that, according to the traditional solution, the door 10 must be provided with a longitudinal lowering at the upper edge, on the front facing the wall 14, so as to create the support seating for the profile section 16 in which the trolley or the trolleys with the wheels 18 run and also to avoid an excessive protrusion of the profile section with respect to said wall. Said profile section, as can be seen from FIG. 3, is secured laterally to the door 10, in particular, to its inner side 10′, by conventional screws 24 and defines a substantially “ [symbol] ”-shaped section, with an upper part provided with an inverted “ [symbol] ”-shaped seat 20 along which the wheel 18 of the already known trolley runs, and a lower part in which at least one known cushioned stop 22 is housed; the latter gradually accompanies the door 10 when closing and/or opening at the end of its stroke. The trolley, according to this known embodiment, is secured with screws 26 or equivalent retaining means to the wall, above the space 12, which, in this case, is completely shielded by the door 10 whose height is higher than that of the space.

According to the invention, with particular reference to FIGS. 4 to 8 in which the same reference numerals of the known solution described above as for the same components are used, the sliding device of the door 10 comprises a guide profile section 28, located at the upper end of the door and is provided, similarly to the profile section 16, with an inverted “ [symbol] ”-shaped seat 20, along which the wheel 18 of the known trolley runs, and with at least one cushioned stop 22. In the lower part adjacent to the floor, the door 10 is instead driven to slide by means of a guide of a known type and with the support of skids or equivalent means.

The support base 30 of the profile section 28, shown in detail in FIG. 6, extends in width by a dimension preferably at least equal to the depth or thickness of the wing constituting the door 10; the profile section 28 rests with said base 30 on the upper end of said door, indicated as 10′ in FIG. 8, which defines this thickness. The profile section 28 is secured to the door 10 with screws 32, engaged vertically along said upper end.

At the front end opposite to the wall 14, the base 30 of the profile section 28 folds orthogonally upwards to form an integral wall 34, which aligns with the front side of the door 10, indicated as 36 in FIGS. 6 and 8. Said front side 36 of the door 10 can advantageously be provided with the coat constituted by the laminatino (not shown), also in its standard dimension whose height is equal to 2,150 mm; the wall 34 is perfectly aligned with this coat, of which it visually constitutes an extension in the form of a band, having a width corresponding to that of the door 10. Said wall 34 of the profile section 28 is therefore able to shield the upper part of a space 12 having a height higher than that of the door 10 with the laminatino coat, advantageously compensating this height that, in most cases, does not exceed 40 mm. The wall 34 of the profile section 28 can in any case have any dimension in height, according to the specific requirements dictated mainly by the height of the space 12; according to a preferred and not limiting embodiment, this height will however advantageously range from 50.0 to 70.0 mm.

In the opposite position with respect to the wall 34, the profile section 28 comprises a lip 38, which extends downwards towards the door 10 starting from the base 30, in particular from the area near the rear end facing the wall 14 of the base. The lip 38, with an orientation height ranging between 2.0 and 4.0 mm, is particularly visible in FIGS. 6 and 8 and acts as a stop for the profile section 28 that, thanks to it, comes into contact with the door 10, on its rear side opposite to its front side 36. On the opposite ends of the profile section 28 there is a conventional closing and finishing cap 40, visible in FIGS. 6, 7 and 8.

The wall 24 of the profile section 28 can be customized from an aesthetic point of view, so as to adapt to the laminatino coat; in this sense, this wall can be painted, or the whole profile section 28 can be subjected to surface finishing treatment such as for example anodic oxidation or anodization, which makes it possible to obtain a surface with multiple colors. Said profile section 28, moreover, can be made in two independent sections, possibly connected to each other in a known manner, both secured with screws to the end of the door 10 starting from a respective area of the base 30; in this hypothesis, one of these sections could comprise, in addition to a part of the base 30, the vertical wall 34 alone.

FIG. 8 shows from above the profile section 28 under practically operating conditions, in which it is about to be permanently secured with the screws 32 to the upper end 10′ of the door 10; the same FIG. 8 shows the presence of two or more rollers 42, unrelated to the solution described and claimed herein and already known, oriented horizontally and partly projecting from the profile section 28 to find the wall 14 during the door 10 opening/closing steps.

As can be seen from the foregoing, the advantages that the invention achieves are evident.

The device for sliding doors coated with industrial laminates of this invention allows to use the laminatino coat also on a door 10 that exceeds the standard size of the coat, equal to 2,150 mm; this is because the residual height, determined, first of all, by the off-standard height dimension of the space 12, is effectively compensated by the band formed by the vertical wall 34 of the profile section 28, extending flush with the upper edge of said door 10 provided with the laminatino coat.

Even more advantageous is the possibility to easily harmonize aesthetically said wall 34 with the type and or color of the laminatino coat, thanks to painting operations or by anodic oxidation surface treatments of the entire profile section 28 or of a part of it comprising said wall 34.

Although the invention has been described above with reference to a possible embodiment thereof, given by way of non-limiting example, numerous changes and variations will be apparent to a person skilled in the art in light of the above description. The present invention, therefore, intends to embrace all changes and variations that fall within the spirit and in the protective scope of the following claims.

1. A device for sliding of doors (10) coated with industrial laminates, in particular coated with “laminatino”, said doors sliding with respect to a wall (14) in which a passage space (12) is obtained, comprising a guide profile section (28) with support base (30), placed at the upper end of the door and provided with an inverted “U” shaped seat (20), along which the wheels (18) of one or more trolleys slide, and at least one cushioned stop (22), characterized in that said profile section (28) is secured to the door (10) starting from its base (30) with screws (32) or equivalent means, fitted vertically along the upper end (10′) of the door.

2. The device according to claim 1, characterized in that the support base (30) of the profile section (28) extends in width by a height at least equal to the depth or thickness of the door (10), at the front end opposite to said wall (14) the base (30) of the profile section (28) being bent orthogonally upwards to form an integral wall (34) that aligns with the coated front side (36) of said door (10).

3. The device according to claim 2, characterized in that the wall (34) of the profile section (28) has a height between 50.0 and 70.0 mm.

4. The device according to claim 3, characterized in that in the opposite position with respect to said wall (34) the profile section (28) is provided with a lip (38), developed downwards towards the door (10) starting from the area near the rear end facing the wall (14) of the base (30).

5. The device according to claim 4, characterized in that said lip (38) has a height between 2.0 and 4.0 mm and fits the rear side opposite to the front side (36) of the door (10).

6. The device according to claim 2, characterized in that the profile section (28) is made of two independent sections, possible connected to each other, both secured with screws to the end of the door (10) starting from a respective base area (30), one of said sections comprising the vertical wall (34).

7. The device according to claim 1, characterized in that at least the vertical wall (34) of the profile section (28) is harmonized aesthetically with the laminatino coat of the door (10).
